(19) United States
(12) Patent Application Publication
(10) Pub. No.: US 2026/0288077 A1
(43) Pub. Date: Sep. 24, 2026

(54) DRIVE CONTROL DEVICE, ELECTRONIC TIMEPIECE, DRIVE CONTROL METHOD, AND STORAGE MEDIUM

(71) Applicant: CASIO COMPUTER CO., LTD., Tokyo (JP)

(72) Inventor: Mitsuaki MATSUO, Tokyo (JP)

(73) Assignee: CASIO COMPUTER CO., LTD., Tokyo (JP)

(21) Appl. No.: 19/571,308

(22) Filed: Mar. 18, 2026

(30) Foreign Application Priority Data
Mar. 24, 2025 (JP) 2025-048778

(51) Int. Cl. G04C 3/14; G04G 9/00

(52) U.S. Cl. CPC G04C 3/14; G04G 9/0064

(57) ABSTRACT

A drive control device includes a processor configured to control a driver that drives a hand to perform a rotational movement by a unit angle. The hand points to one of specific positions each time the hand performs the rotational movement by the unit angle a unit number of times that is plural, thereby performing rotational movements corresponding to the unit number of times. In a case of changing a position to which the hand points from one specific position to another specific position of the specific positions for each reference period, the processor sets unit-period intervals between the rotational movements to be either uniform or non-uniform.

### BACKGROUND OF THE INVENTION

### Technical Field

The present disclosure relates to a drive control device, an electronic timepiece, a drive control method, and storage medium.

### Description of Related Art

There are electronic devices that display time (a point in time) or the like by using stepping motors to discretely rotate/move hands by their predetermined angles. JPH 11-218587 A discloses a technology of, in a case where the remaining battery level of such an electronic device is low, notifying its user of the low remaining battery level by stopping or changing the movement of some or all of the hands.

### SUMMARY OF THE INVENTION

According to an aspect of the present disclosure, there is provided a drive control device including a processor configured to control a driver that drives a hand to perform a rotational movement by a unit angle,
wherein the hand points to one of specific positions each time the hand performs the rotational movement by the unit angle a unit number of times that is plural, thereby performing rotational movements corresponding to the unit number of times, and
wherein in a case of changing a position to which the hand points from one specific position to another specific position of the specific positions for each reference period, the processor sets unit-period intervals between the rotational movements to be either uniform or non-uniform.

Further features of the present invention will become apparent from the following description of exemplary embodiments (with reference to the attached drawings).

### BRIEF DESCRIPTION OF DRAWINGS

FIG. 1 is a block diagram showing a functional configuration of an electronic timepiece of an embodiment(s).

FIG. 2A illustrates movement timings of a second hand.

FIG. 2B illustrates movement timings of the second hand.

FIG. 3 is a flowchart showing a control procedure for a sweep movement control process.

FIG. 4A illustrates an example of output timings of drive pulses.

FIG. 4B illustrates an example of output timings of drive pulses.

FIG. 4C illustrates an example of output timings of drive pulses.

FIG. 5 is a flowchart showing a control procedure for a sweep movement control process of another embodiment.

FIG. 6 is a flowchart showing a control procedure for a sweep movement control process of another embodiment.

FIG. 7 is a flowchart showing a control procedure for a sweep movement control process of another embodiment.

### DETAILED DESCRIPTION

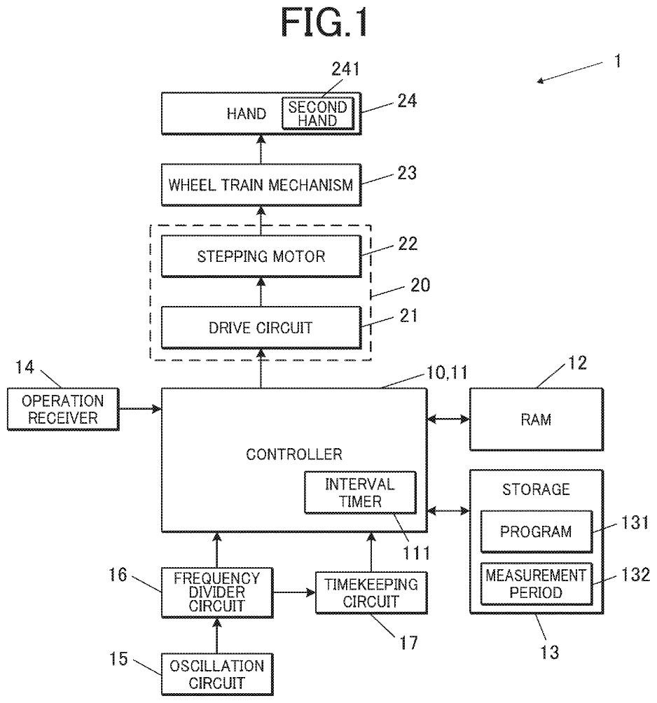

Hereinafter, one or more embodiments of the present disclosure will be described on the basis of the drawings. As shown in the block diagram of FIG. 1, an electronic timepiece 1 includes a controller 11, a random access memory (RAM) 12, a storage 13, an operation receiver 14, an oscillation circuit 15, a frequency divider circuit 16, a timekeeping circuit 17 (timing module), a drive circuit 21, a stepping motor 22, a wheel train mechanism 23, and a hand 24. The electronic timepiece 1 may be a portable electronic timepiece, such as a wristwatch.

The controller 11 has a processor that controls the overall operation of the electronic timepiece 1. The processor may be a general-purpose central processing unit (CPU), or may be a microcontroller, an integrated circuit (IC), a large-scale integrated circuit (LSI) or the like suitable for operating a timepiece. The controller 11 may have a single processor, or may have multiple processors that independently perform processes depending on the application or the like. Alternatively, the multiple processors may work together to perform processes in parallel. The controller 11 includes an interval timer 111. The interval timer 111 may not be a hardware component, and simply the controller 11 may count clock signals to calculate/measure the elapsed time. The interval timer 111 starts the counting/measurement in response to a trigger and outputs an interrupt signal when having measured a specified time. Hereinafter, this interrupt signal may be referred to as a “timer interrupt”.

The RAM 12 provides the controller 11 with a memory space for work and stores temporary data. The RAM 12 stores, for example, data of the number of movements of the hand 24 per second.

The storage 13 has a nonvolatile memory and stores programs 131, setting data, and so forth. The setting data includes measurement periods 132. The measurement periods 132 define intervals (unit-period intervals) between rotational movements of a second hand 241. The measurement periods 132 will be described later. The nonvolatile memory may be, for example, a flash memory. As long as it is usable as a nonvolatile memory, the type of nonvolatile memory is not specifically limited. At least the controller 11 is included in a drive control device 10 of this embodiment, and the storage 13 may also be included in the drive control device 10.

The operation receiver 14 receives input operations from the outside and outputs, to the controller 11, operation signals corresponding to the contents of the received input operations. The operation receiver 14 may have, for example, a pushbutton switch. The operation receiver 14 may also have a crown, a slide switch, and another operation mechanism.

The oscillation circuit 15 includes, for example, a quartz crystal resonator and a resonance circuit, and generates clock signals of around the resonant frequency of the quartz crystal resonator. The resonant frequency may be, for example, 32.768 kHz or 16.384 kHz. This frequency changes depending on the environmental conditions, such as temperature, in addition to the adjustment accuracy of the quartz crystal resonator. The quartz crystal resonator may be an AT-cut crystal that is stable around room temperature against temperature change. The frequency divider circuit 16 divides the frequency of the clock signals to obtain signals of an appropriate frequency and outputs the frequency-divided signals. The frequency of the frequency-divided signals may be multiple and determined in accordance with the frequency necessary for each component of the electronic timepiece 1. The frequency-divided signals may include a 1-Hz signal for measuring the date and time, i.e., a one-second (reference period) signal.

The timekeeping circuit 17 may count 1-Hz signals to obtain the current date and the current time, i.e., the date and time, in units of one second (reference period). In other words, the timekeeping circuit 17 does not measure fractions of a second. The operation of the timekeeping circuit 17 may be included in the software operation of the controller 11. In other words, the electronic timepiece 1 may not have the timekeeping circuit 17 as a hardware component. Separate from the operation of the controller 11 as the timekeeping circuit 17, the electronic timepiece 1 may have a real time clock (RTC) as a hardware component.

The drive circuit 21 outputs drive pulses to the stepping motor 22 based on the control by the controller 11. The stepping motor 22 rotates/moves by a specific angle in response to each input drive pulse. The wheel train mechanism 23 is a gear train that converts the rotation of the stepping motor 22 into rotation of the hand 24. The hand 24 is a needle-like object used for a display operation synchronized with time, mainly for time display, and rotates (moves or performs a rotational movement) on a plane along the display surface of the electronic timepiece 1 by a predetermined angle in response to the operation of the wheel train mechanism 23, i.e., the operation of the stepping motor 22. The hand 24 may include the second hand 241, a minute hand, and an hour hand. The hand 24 may include a hand(s) other than the second hand 241, the minute hand, and the hour hand. The other hand may have a rotation axis at a position different from that of the second hand 241, the minute hand and the hour hand. The drive circuit 21 and the stepping motor 22 correspond to a driver 20 of this embodiment. The operation of the driver 20 is controlled by the controller 11. The drive circuit 21 is capable of outputting drive pulses for fast-forwarding the hand 24. The fast-forwarding speed may be, for example, 32 to 90 steps per second. The fast-forwarding speed may differ between when the hand 24 is moved in the forward direction, i.e., clockwise, and when it is moved in the reverse direction, i.e., counterclockwise.

Next, a drive control method for the hand 24 of the electronic timepiece 1 of this embodiment will be described. As described above, in the electronic timepiece 1, time is displayed by the rotations of the second hand 241, the minute hand and the hour hand. At least the second hand 241 performs rotational movements independently of the other hands. The second hand 241, the minute hand and the hour hand may be caused to perform the rotational movements independently of one another by their respective stepping motors 22 and wheel train mechanisms 23. Alternatively, the minute hand and the hour hand may rotate in conjunction with one another. In other words, the electronic timepiece 1 may have a wheel train mechanism 23 that rotates the hour hand by a rotation angle equal to 1/12 of that of the minute hand in response to the operation of their common stepping motor 22.

In the time display operation, the second hand 241 of the electronic timepiece 1 performs the rotational movements at intervals shorter than the reference period of one second, making one revolution per minute on the display surface. The interval(s) between the rotational movements (unit-period interval(s)) of the second hand 241 may be, for example, a time (period or time length) obtained by dividing the reference period by an integer of two or more, 12 in this embodiment, i.e., may be about 1/12 seconds, and accordingly the second hand 241 performs 12 rotational movements per second. A typical second hand, which performs one rotational movement per second, rotates six degrees at a time. In contrast, the second hand 241 of this embodiment may rotate an angle (unit angle) obtained by dividing six degrees by 12, i.e., 0.5 degrees, at a rotational movement. In other words, by performing 12 (unit number of times) rotational movements per reference period, the second hand 241 changes its position from one of positions each indicating an exact second (specific positions), which has a decimal point of zero, to the next one (another one) every reference period. The rotational movements at such fine, substantially uniform intervals appear to the user to be smooth rotation, and are referred to as “sweep movement”. The minute hand and the hour hand may rotate in their typical manners. For example, the minute hand may perform one rotational movement every ten seconds, and the hour hand may perform one rotational movement every two minutes.

A typical electronic timepiece outputs a synchronization signal at the timing of each exact second, and measures time and moves a second hand (and so forth). The electronic timepiece 1 of this embodiment, in addition to the above, repeatedly measures, with the interval timer 111, the interval between the rotational movements of the second hand 241, which hereinafter may be referred to as “hand movements”, in each second, thereby determining the timing of each rotational movement of the second hand 241 other than the timing of second synchronization thereof. In other words, the electronic timepiece 1 does not raise the output frequency of synchronization signals according to the number of rotational movements of the second hand 241.

Thus, the electronic timepiece 1 keeps conventional-and-accurate second synchronization signals, and determines the hand-movement timings of less than one second while synchronizing some of the hand movements and a timekeeping process with the signals. In this case, even when the hand-movement timings for the unit number of times, which is the number of rotational movements of less than one second, slightly deviate from strict uniform intervals, the deviations are initialized and eliminated at the timing of a second synchronization signal. This prevents deviations in measuring time from being cumulated. Therefore, the accuracy of a time measured by the interval timer 111 may not be high as long as the intervals between the rotational movements of the second hand 241 do not appear to the user to be unnatural. Hereinafter, the unit-period intervals that are visually perceived by the user as substantially uniform are referred to as “uniform unit-period intervals”. For example, unit-period intervals having a difference of about ten milliseconds or a difference of up to about 40 milliseconds may be included in the uniform unit-period intervals. In particular, even if a unit-period interval(s) is defined by the reciprocal of a frequency containing a multiple of a prime number other than 2, it is unnecessary to raise the frequency to improve the accuracy. Accordingly, the electronic timepiece 1 can suppress increases in manufacturing and operational costs and power consumption.

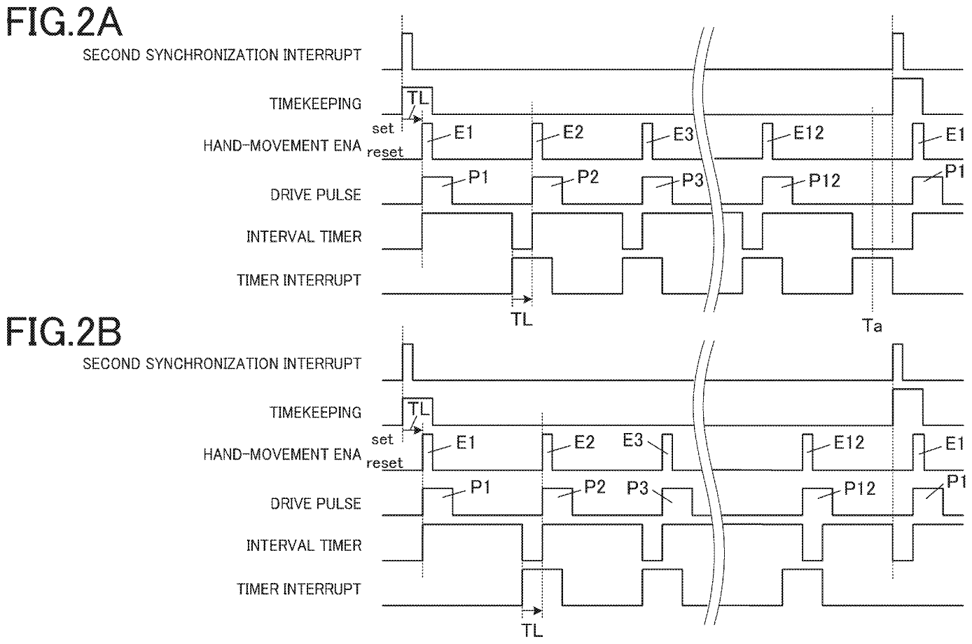

FIG. 2A and FIG. 2B illustrate timings for the sweep movement, in which the second hand 241 performs 12 rotational movements per second. In the electronic timepiece 1, the operation (movement) of the second hand 241 is controlled by an interrupt process based on second synchronization signals and an interrupt process with the interval timer 111 measuring about 1/12 seconds. When a second synchronization signal is output, an interrupt signal occurs and the timekeeping process is performed to update the current date and time. With this, a hand-movement enable signal (ENA), which enables the rotational movement of the second hand 241, is set, for example, to be a high level, and is output to the drive circuit 21 as a first signal. The hand-movement enable signal may be a flag set in the drive circuit 21. A drive pulse is output from the drive circuit 21 to the stepping motor 22. In synchronization with this drive pulse, the interval timer 111, which measures about 1/12 seconds, starts the measurement. Although 1/12 seconds are 83.3 milliseconds, the unit-period intervals at which the drive pulse is output may deviate within the range of uniform unit-period intervals as described above. For example, the unit period may be around 81 to 85 milliseconds. Alternatively, as described later, the unit-period intervals may be non-uniform, i.e., outside the range of uniform unit-period intervals.

It is noted that, in practice, there is a time lag TL between when an interrupt signal related to a hand movement is input and when a drive pulse is actually output. Therefore, the interval timer 111 may measure a time obtained by subtracting a time corresponding to this time lag TL from the unit-period interval, as a standby period before starting a process for outputting the next drive pulse. For example, the standby period may be about 80 milliseconds. When the drive pulse is output from the drive circuit 21 to the stepping motor 22 in response to the set hand-movement enable signal, the hand-movement enable signal is reset, for example, to be a low level.

When the interval timer 111 measures the standby period, an interrupt signal is output. Based on a timer interrupt related to this interrupt signal, each time the unit-period interval elapses, the controller 11 sets the hand-movement enable signal, which enables the rotational movement of the second hand 241, and outputs it as a second signal to the drive circuit 21. Accordingly, the drive circuit 21 outputs the drive pulse. In other words, the first hand movement in each second is based on a second synchronization signal, and a hand-movement enable signal E1 is the first signal. The second to 12^{th} hand movements in each second are each based on a timer interrupt corresponding to the measurement by the interval timer 111, and hand-movement enable signals E2 to E12 are each the second signal. The timekeeping process may not be performed in response to the timer interrupt. In other words, the timekeeping circuit 17 may measure time in units of one second.

As shown in FIG. 2A, the controller 11 counts the number of times the hand-movement enable signal is set, i.e., the number of set times of hand-movement enable signals (E1 to E12), or the number of times the drive pulse is output, i.e., the number of output times of drive pulses (P1 to P12), in each second. The controller 11 sets no hand-movement enable signal after the 12^{th} hand-movement enable signal E12 or the 12^{th} drive pulse P12 is output in each second. If the output interval(s) (unit-period interval(s)) of the drive pulses is shorter than 83.3 milliseconds, after the 12^{th} drive pulse P12 is output, the 13^{th} timer interrupt occurs. The controller 11 sets no hand-movement enable signal at a timing Ta corresponding to the 13^{th} timer interrupt. Therefore, no drive pulse is output from the drive circuit 21 in response to the 13^{th} timer interrupt or any subsequent timer interrupt. When one second elapses and the next second synchronization signal is input, the counted value of the number of times the hand-movement enable signal is set or the number of times the drive pulse is output is initialized to be counted again from “1”. With this, a hand-movement enable signal corresponding to that next second synchronization interrupt is set.

On the other hand, as shown in FIG. 2B, if the output interval(s) of the drive pulses is longer than 83.3 milliseconds, after the 12^{th} drive pulse P12 is output, a second synchronization interrupt accompanying a second synchronization signal occurs while the interval timer 111 is measuring the standby period. In this case, the measurement by the interval timer 111 is stopped even if it is in progress, and the counted value of the number of times the hand-movement enable signal is set or the number of times the drive pulse is output is initialized. In response to a hand-movement enable signal E1 or a drive pulse P1 based on a second synchronization interrupt, the number of times the hand-movement enable signal is set or the number of times the drive pulse is output is counted again from “1”.

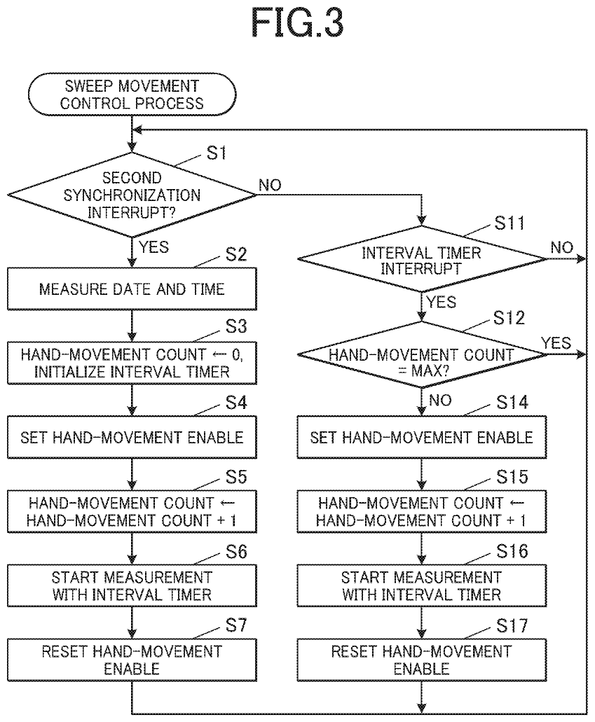

As shown in the flowchart of FIG. 3, part of the above procedure is performed as software control by the controller 11 with respect to the interrupt processes. The controller 11 determines whether there has been an interrupt signal for second synchronization (S1). If the controller 11 determines that there has been an interrupt signal for second synchronization (S1; YES), the controller 11 measures the date and time (S2). The controller 11 adds one second to the current date and time. The controller 11 initializes a hand-movement count (i.e., the number of rotational movements of the second hand 241) within a second to zero and initializes the measurement by the interval timer 111 (S3).

The controller 11 sets a hand-movement enable signal (S4). Accordingly, the drive circuit 21 outputs a drive pulse to the stepping motor 22. The controller 11 adds “1” to the hand-movement count for the second (S5). The controller 11 starts the measurement with the interval timer 111 (S6). The controller 11 resets the hand-movement enable signal (S7). The controller 11 then returns to Step S1.

If the controller 11 determines that there has been no interrupt signal for second synchronization (S1; NO), the controller 11 determines whether there has been an interrupt signal from the interval timer 111 (S11). If the controller 11 determines that there has been no interrupt signal from the interval timer 111 (S11; NO), the controller 11 returns to Step S1.

If the controller 11 determines that there has been an interrupt signal from the interval timer 111 (S11; YES), the controller 11 determines whether the hand-movement count is the maximum value MAX, “12” in this embodiment (S12). If the controller 11 determines that the hand-movement count is the maximum value MAX (S12; YES), the controller 11 returns to Step S1.

If the controller 11 determines that the hand-movement count is not the maximum value MAX (S12; NO), the controller 11 sets a hand-movement enable signal (S14). Accordingly, the drive circuit 21 outputs a drive pulse to the stepping motor 22. The controller 11 adds “1” to the hand-movement count (S15). The controller 11 starts the measurement with the interval timer 111 (S16). The controller 11 resets the hand-movement enable signal (S17). The controller 11 then returns to Step S1.

The measurement by the interval timer 111 may be started mechanically in conjunction with the output of a drive pulse to the stepping motor 22. Steps S1 to S7 and Steps S11 to S17 may be different processes that are started independently of one another with respect to their respective interrupts.

As described above, the first rotational movement of the second hand 241 in each second is fixed by being associated with a second synchronization signal, i.e., the start timing of each second. On the other hand, the second to 12^{th} rotational movements of the second hand 241 in each second are independent of the timekeeping process. Therefore, unit-period intervals ti1 to ti12 are not only subject to adjustment-related variations but also can be changed as appropriate. Changing standby periods tt that are measured by the interval timer 111 change the unit-period intervals ti1 to ti11. The remaining time of one second after the unit-period intervals ti1 to ti11, i.e., the remaining time obtained by subtracting the unit-period intervals ti1 to ti11 from one second, is a unit-period interval ti12. The combination of such unit-period intervals ti1 to ti12 can define a hand movement pattern for each reference period.

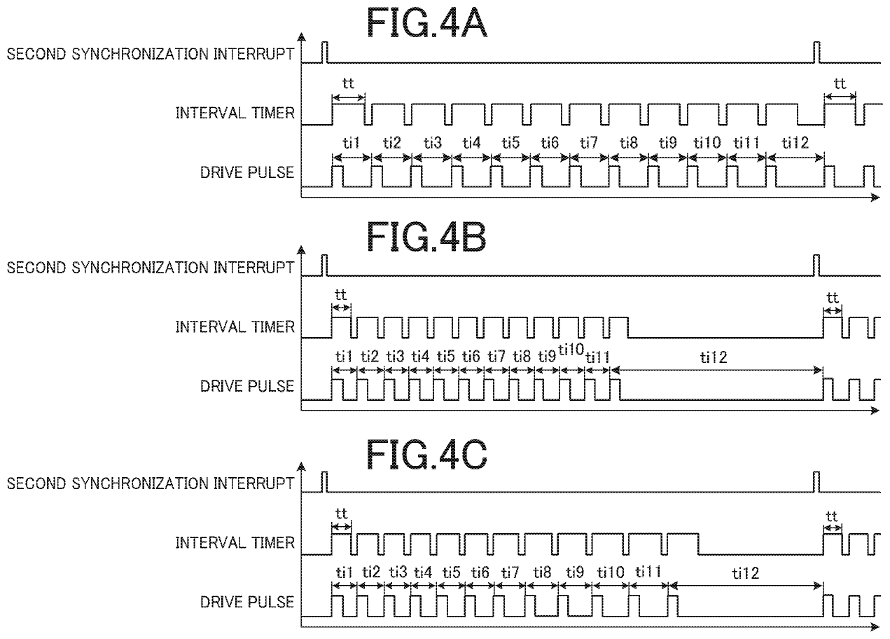

As shown in FIG. 4A, drive pulses for the unit number of times per second, 12 drive pulses in this embodiment, are output at unit-period intervals ti1 to ti11. As described above, the unit-period intervals ti1 to ti11 may all be the same. In other words, the interval timer 111 may measure the same standby period tt for the unit-period intervals ti1 to ti11. The unit-period interval ti12 between the 12^{th} drive pulse and the first drive pulse in the next second being the same as each of the unit-period intervals ti1 to ti11 produces the sweep movement in which the second hand 241 performs the rotational movements at perfectly uniform intervals. When the unit-period interval ti12 is not greatly different from each of the unit-period intervals ti1 to ti11, an unnatural deviation from the sweep movement is unlikely to be visually perceived. Thus, such a difference between each of the unit-period intervals ti1 to ti11 and the unit-period interval ti12 may fall in the range of uniform unit-period intervals. This is referred to as a “first display mode” or “first state”.

Alternatively, as shown in FIG. 4B, the difference between each of the unit-period intervals ti1 to ti11 and the unit-period interval ti12 may not fall in the range of uniform unit-period intervals, i.e., they may be greatly different from one another, while the unit-period intervals ti1 to ti11 are the same. This is referred to as a “second display mode” or “second state”. In this case, the unit-period interval ti12 may be significantly longer than each of the unit-period intervals ti1 to ti11. The unit-period interval ti12 may be, for example, 100 milliseconds or more, or even 250 milliseconds or more, longer than each of the unit-period intervals ti1 to ti11. In this case, the rotational movements of the second hand 241 are concentrated in a segment starting from the beginning of each second. This allows the user to visually perceive the second hand 241 intermittently moving between exact-second positions (specific positions) while pausing at the exact-second positions. Therefore, the user can more easily read the second(s) in the current time.

As shown in FIG. 4C, the unit-period intervals ti1 to ti11 may not be the same. FIG. 4C shows a third display mode (third state) in which the unit-period intervals ti1 to ti11 become progressively longer toward the end. In this case, the second hand 241 starts moving rapidly from each exact-second position, and then decelerates to reach the next exact-second position. As in the example shown in FIG. 4B, the unit-period interval ti12 being significantly longer than each of the unit-period intervals ti1 to ti11 allows the user to visually perceive the second hand 241 intermittently moving between exact-second positions while pausing gently at the exact-second positions. In other words, such rotational movements of the second hand 241 keep the smooth movement of the second hand 241 and also provide high visibility in practice use.

These various display modes, which are defined by the unit-period intervals ti1 to ti11, may be switchable based on the display state or a user's request, i.e., the content of a setting operation. In addition to the simple time display, examples of the display state include a setting of an alarm notification operation, a notification of a low battery level, a notification of a received e-mail or SNS message from an external source, and a notification of scheduled time (point in time) set externally. For example, when or before one of the above is performed in addition to the simple time display, the sweep movement may be switched to the movement that includes pausing. Thus, a hand movement pattern different from a hand movement pattern of continuous uniform intervals may allow the user to easily recognize that some kind of event is occurring or has occurred. It may be possible to perform control such that the rotational movements shown in FIG. 4A and the rotation movements shown in FIG. 4B or FIG. 4C are periodically switched at appropriate timings. The standby periods tt, which are measured by the interval timer 111 and determined in accordance with the unit-period intervals ti1 to ti11, i.e., data of the standby periods tt, may be stored in advance in the storage 13 as the measurement periods 132. When the unit-period intervals ti1 to ti11 for a selected display mode are set, the controller 11 may read out the standby period(s) tt corresponding thereto from the measurement periods 132 stored in the storage 13 and store it/them in the RAM 12 or a register of the drive circuit 21.

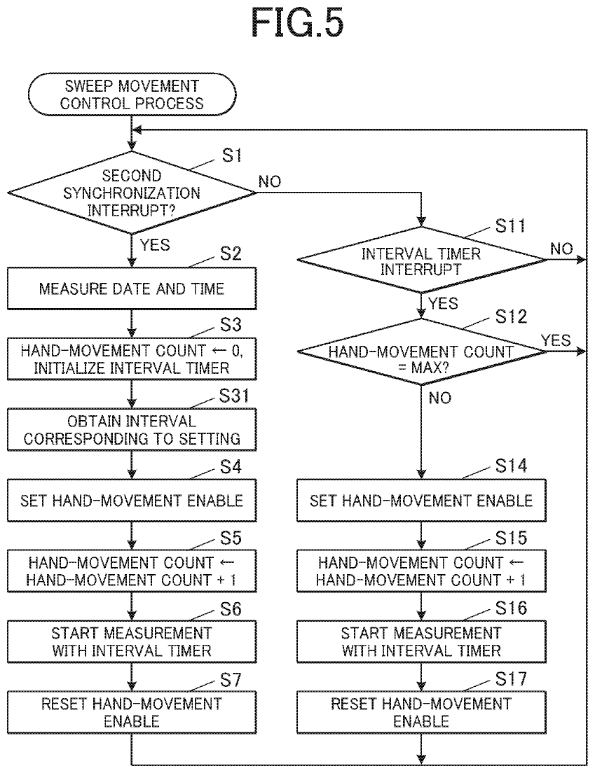

In the flowchart of the sweep movement control process shown in FIG. 5, Step S31 is added so that the uniform unit-period intervals ti1 to ti11 can be changed as shown in FIG. 4A and FIG. 4B. The sweep movement control process shown in FIG. 5 is the same as that shown in FIG. 3 except for Step S31. The steps having the same contents as those in the sweep movement control process shown in FIG. 3 are provided with the same step numbers, and their detailed descriptions will be omitted.

After Step S3, the controller 11 refers to the measurement periods 132 in the storage 13 to obtain a standby period tt to be measured by the interval timer 111, the standby period tt corresponding to a setting (S31). The controller 11 writes the obtained standby period tt, for example, into the register of the drive circuit 21 and reads it out at the time of the operation of the interval timer 111. The controller 11 then moves to Step S4.

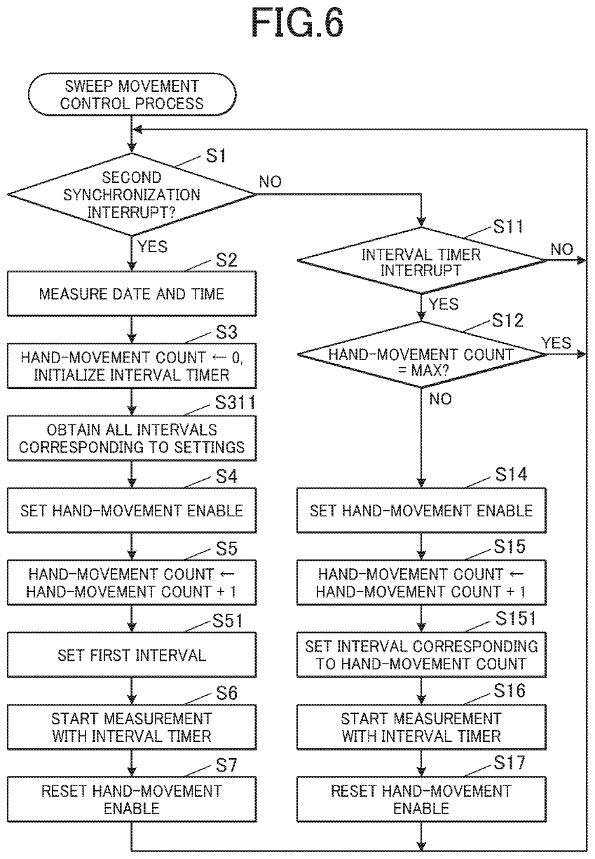

In the flowchart of the sweep movement control process shown in FIG. 6, the unit-period intervals ti1 to ti11 are set separately as shown in FIG. 4C. For this purpose, Steps S311, S51 and S151 are added to the sweep movement control process shown in FIG. 3. The sweep movement control process shown in FIG. 6 is the same as that shown in FIG. 3 except for Steps S311, S51 and S151. The steps having the same contents as those in the sweep movement control process shown in FIG. 3 are provided with the same step numbers, and their detailed descriptions will be omitted.

After Step S3, the controller 11 obtains all standby periods tt corresponding to the unit-period intervals ti1 to ti11 corresponding to settings from the measurement periods 132 in the storage 13 and stores them in the RAM 12 or the like (S311). The controller 11 then moves to Step S4.

After Step S5, the controller 11 reads out, from the RAM 12, a standby period tt corresponding to the first unit-period interval ti1 and writes it into the register of the drive circuit 21 (S51). The controller 11 then moves to Step S6.

After Step S15, the controller 11 reads out, from the RAM 12, a standby period tt corresponding to one of the unit-period intervals ti2 to ti11 corresponding to the hand-movement count and writes it into the register of the drive circuit 21 (S151). The controller 11 then moves to Step S16.

In other words, in Step S51 and Step S151, the unit-period intervals (standby periods tt) for the respective hand movements may be changed in order. The standby periods tt for all the unit-period intervals ti1 to ti11 may be collectively writable into the drive circuit 21, and at the start of each hand movement, the drive circuit 21 may be able to set its corresponding unit-period interval. In this case, in Step S311, the controller 11 may obtain the standby periods tt, which correspond to the respective unit-period intervals ti1 to ti11, and write them as they are into the register of the drive circuit 21. In Step S51 and Step S151, it is sufficient for the controller 11 to determine the standby period tt corresponding to the hand-movement count.

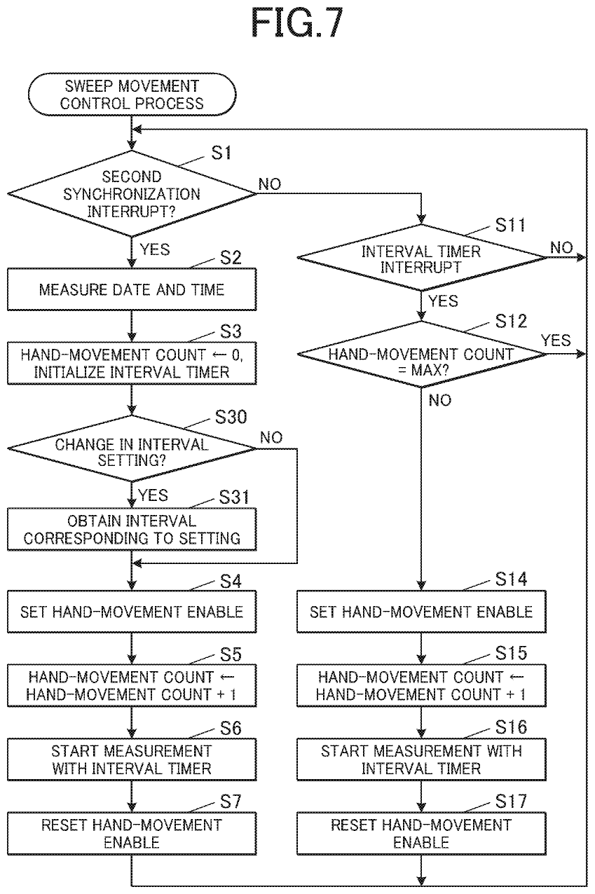

In a case where the rotational movements shown in FIG. 4A and those shown in FIG. 4B are periodically switched or irregularly switched, for example, in accordance with the display state or in response to an operation being input, the controller 11 may not perform, in the sweep movement control process shown in FIG. 5, Step S31 every time; instead, may determine before Step S31 whether there is a change in interval setting. FIG. 7 shows a flowchart that is the same as that shown in FIG. 5 with Step S30 added. That is, after Step S3, the controller 11 determines whether there is a change in interval setting (S30). If the controller 11 determines that there is a change in interval setting (S30; YES), the controller 11 moves to Step S31. If the controller 11 determines that there is no change in interval setting (S30; NO), the controller 11 moves to Step S4. The contents of the other steps are the same as those shown in FIG. 5, and therefore their detailed descriptions will be omitted.

As described above, the drive control device 10 of this embodiment includes the controller 11 that controls the driver 20 that drives the second hand 241 to perform a rotational movement by a unit angle. The second hand 241 points to one of specific positions each time the second hand 241 performs the rotational movement by the unit angle a unit number of times that is plural, thereby performing rotational movements corresponding to the unit number of times. In a case of changing a position to which the second hand 241 points from one specific position to another specific position of the specific positions for each reference period, the controller 11 sets unit-period intervals between the rotational movements to be either uniform or non-uniform. According to this drive control device 10, the movement patterns for the second hand 241, which is capable of the sweep movement, can be diversified. Therefore, the drive control device 10 can flexibly change the movement state of the hand 24 (second hand 241) according to the situation.

There is a technology for, in an electronic timepiece, smoothly changing display by dividing an interval between rotational movements of a second hand into intervals of less than one second to cause the second hand to perform fine movements. However, JPH 11-218587 A mentioned above fails to disclose anything about the problem that such fine-step and high-frequency movements may make it difficult for the user to precisely read the contents indicated by the hand(s) in practice. In contrast, the drive control device 10 of this embodiment can flexibly change the movement state of the hand 24 (second hand 241).

Further, the specific positions may each indicate an exact second. In other words, in the case where the second hand 241 moves between the exact-second positions by multiple steps, the intervals between the rotational movements may be switchable as appropriate to be either uniform or non-uniform, as described above. This realizes not only the normal sweep movement but also various other hand movements according to the situation. Further, such different hand movement patterns can produce various visual effects.

Further, the controller 11 may cause the second hand 241 to perform the first rotational movement in each second by associating it with the start timing of each second. Associating the first rotational movement with an exact second allows the user to properly recognize an exact-second timing, regardless of the timings of the second and subsequent rotational movements.

Further, the controller 11 may perform control to switch between two states that are the first state in which the rotational movements corresponding to the unit number of times are performed at uniform intervals and the second state in which the rotational movements corresponding to the unit number of times are performed concentratively in a segment starting from the beginning of each second. Although the sweep movement is effective in creating a sense of luxury or the like from its smoothness, it sometimes makes it difficult for the user to read the position to which the second hand 241 points. Concentratively performing the rotational movements corresponding to the unit number of times in such a segment and pausing the second hand 241 in the remaining segment makes it easy for the user to read the position to which the second hand 241 points when it stops, while keeping the smooth transitional movement of the second hand 241.

Further, the hand 24 includes the second hand 241. In response to receiving a request from the outside, the controller 11 may switch from the first state to the second state to cause the second hand 241 to perform the rotational movements. In other words, switching the states, i.e., inserting a pause of the second hand 241 at a timing desired by the user while normally causing the second hand 241 to perform the sweep movement, makes it easy for the user to read the second(s) only when the user needs it.

Further, in a case where a point in time or an elapsed time is displayed, the controller 11 may periodically switch the rotational movements in the first state and the rotational movements in the second state. Occasionally improving the legibility of the position of the second hand 241 can enhance usability. Alternatively, regularly changing the mode of the hand movements can create diversity in the operation of the electronic timepiece 1.

Further, the drive control device 10 further includes the storage 13 that stores, as the measurement periods 132, predetermined setting values related to the unit-period intervals corresponding to the unit number of times. The controller 11 may change the unit-period intervals corresponding to the unit number of times in order in accordance with the setting values read out from the storage 13. In other words, the unit-period interval may be changed each time. This enables acceleration and deceleration of the movement of the second hand 241 and adds elegance to the movement of the second hand 241 at the start and/or the end of the movement.

Further, the electronic timepiece 1 includes the drive control device 10 described above, the hand 24 including the second hand 241, and the driver 20 that, based on the control by the controller 11, drives the second hand 241 to perform the rotational movements corresponding to the unit number of times per second. According to this electronic timepiece 1, the movement patterns for the second hand 241, which is capable of the sweep movement, can be diversified. Therefore, the electronic timepiece 1 can flexibly change the movement state of the second hand 241 according to the situation.

Further, the drive control method of this embodiment includes, in a case of changing a position to which the second hand 241 points from one specific position to another specific position of the specific positions for each reference period, setting unit-period intervals between the rotational movements to be either uniform or non-uniform. According to this drive control method, the movement patterns for the second hand 241, which is capable of the sweep movement, can be diversified. Therefore, the drive control method can flexibly change the movement state of the hand 24 (second hand 241) according to the situation.

The present disclosure is not limited to the above embodiment, and various modifications can be made. For example, in the above, the first rotational movement in each second is associated with second synchronization. Even so, the first rotational movement in each second may be set to start not immediately after the second synchronization but after a lapse of the standby period. Alternatively, the first standby period tt may start being measured with no rotational movement performed in the timekeeping process, and 12 rotational movements of the second hand 241 may be performed after the measurement of their respective standby periods tt.

Further, in the above, the unit-period intervals (standby periods tt) are each determined, stored and read out, but not limited thereto. For example, a formula or the like may be set, and the unit-period intervals may be determined by the formula. Further, the unit-period intervals may not be set directly by the user; instead, the electronic timepiece 1 may have several patterns thereof from which the user can select one.

Further, in the above, a user operation is received to make a switch from the first state to the second state, but a switch (i.e., return) from the second state to the first state may be automatically performed when a specific time elapses. Alternatively, receiving a user operation may be required for this switch (i.e., return) too.

Further, in the case where the first state and the second state are periodically switched, the duration of the first state and the duration of the second state may be able to be set separately. These durations may be different from one another. Alternatively, the duration of the first state and the duration of the second state may be able to be set so as to change with the passage of time.

Further, the reference period may not be one second. In a case where the timekeeping frequency of the timekeeping circuit 17 is not once per second, the reference period may be determined in accordance with the timekeeping frequency. Alternatively, the reference period may be determined in accordance with the interval between multiple timekeeping processes.

Further, in the above, the time display by the second hand 241 has been described, but the present disclosure is not limited thereto. For example, the remaining time to a specific point in time may be timer-measured by being synchronized with time and displayed by a hand. Further, the hand capable of the sweep movement may not be the second hand 241. It may be another type of hand, such as a functional hand. Further, the electronic timepiece 1 may not be a wristwatch. It may be another type of timepiece, such as a table clock or a pocket watch.

Further, in the above, the computer-readable medium storing the program(s) 131 for the drive control of the present disclosure is the storage 13 composed of a nonvolatile memory, such as an HDD and/or a flash memory, but not limited thereto. As the non-transitory computer-readable storage medium, another type of nonvolatile memory, such as an MRAM, or a portable storage medium, such as a CD-ROM or a DVD disk, may be used. Further, as a medium that provides data of the programs of the present disclosure via a communication line, a carrier wave is also applicable to the present disclosure. The specific configurations/components, contents of and procedures for the processes, and so forth described in the above embodiment can be changed as appropriate without departing from the scope of the present disclosure. The scope of the present invention includes the scope of claims and their equivalents.

This application claims the benefit of Japanese Patent Application No. 2025-048778, filed Mar. 24, 2025 which is hereby incorporated by reference wherein in its entirety.

1. A drive control device comprising a processor configured to control a driver that drives a hand to perform a rotational movement by a unit angle,
wherein the hand points to one of specific positions each time the hand performs the rotational movement by the unit angle a unit number of times that is plural, thereby performing rotational movements corresponding to the unit number of times, and
wherein in a case of changing a position to which the hand points from one specific position to another specific position of the specific positions for each reference period, the processor sets unit-period intervals between the rotational movements to be either uniform or non-uniform.

2. The drive control device according to claim 1, wherein the specific positions each indicate an exact second.

3. The drive control device according to claim 1, wherein the processor causes the hand to perform a rotational movement of the rotational movements as a first rotational movement in each second by associating the first rotational movement with a start timing of each second.

4. The drive control device according to claim 1, wherein the processor performs control to switch between a first state in which the rotational movements corresponding to the unit number of times are performed at uniform intervals and a second state in which the rotational movements corresponding to the unit number of times are performed concentratively in a segment starting from a beginning of each second.

5. The drive control device according to claim 4,
wherein the hand includes a second hand, and
wherein in response to receiving a request from outside, the processor switches from the first state to the second state to cause the second hand to perform the rotational movements.

6. The drive control device according to claim 4,
wherein the hand includes a second hand, and
wherein in a case where a point in time or an elapsed time i displayed, the processor periodically switches the rotational movements in the first state and the rotational movements in the second state.

7. The drive control device according to claim 1, further comprising a storage that stores predetermined setting values related to the unit-period intervals corresponding to the unit number of times,
wherein the processor changes the unit-period intervals corresponding to the unit number of times in order in accordance with the setting values read out from the storage.

8. An electronic timepiece comprising:
the drive control device according to claim 1;
the hand including a second hand; and
the driver that, based on the control by the processor, drives the second hand to perform the rotational movements corresponding to the unit number of times per second.

9. An electronic timepiece comprising:
the drive control device according to claim 2;
the hand including a second hand; and
the driver that, based on the control by the processor, drives the second hand to perform the rotational movements corresponding to the unit number of times per second.

10. An electronic timepiece comprising:
the drive control device according to claim 3;
the hand including a second hand; and
the driver that, based on the control by the processor, drives the second hand to perform the rotational movements corresponding to the unit number of times per second.

11. An electronic timepiece comprising:
the drive control device according to claim 4;
the hand including a second hand; and
the driver that, based on the control by the processor, drives the second hand to perform the rotational movements corresponding to the unit number of times per second.

12. An electronic timepiece comprising:
the drive control device according to claim 7;
the hand including a second hand; and
the driver that, based on the control by the processor, drives the second hand to perform the rotational movements corresponding to the unit number of times per second.

13. A drive control method comprising controlling a driver that drives a hand to perform a rotational movement by a unit angle,
wherein the hand points to one of specific positions each time the hand performs the rotational movement by the unit angle a unit number of times that is plural, thereby performing rotational movements corresponding to the unit number of times, and
wherein the drive control method further comprises, in a case of changing a position to which the hand points from one specific position to another specific position of the specific positions for each reference period, setting unit-period intervals between the rotational movements to be either uniform or non-uniform.

14. The drive control method according to claim 13, wherein the setting includes performing control to switch between a first state in which the rotational movements corresponding to the unit number of times are performed at uniform intervals and a second state in which the rotational movements corresponding to the unit number of times are performed concentratively in a segment starting from a beginning of each second.

15. The drive control method according to claim 13, wherein the setting includes changing the unit-period intervals corresponding to the unit number of times in order in accordance with predetermined setting values related to the unit-period intervals corresponding to the unit number of times read out from a storage that stores the predetermined setting values.

16. A non-transitory computer-readable storage medium storing a program causing a computer of a drive control device to control a driver that drives a hand to perform a rotational movement by a unit angle,
wherein the hand points to one of specific positions each time the hand performs the rotational movement by the unit angle a unit number of times that is plural, thereby performing rotational movements corresponding to the unit number of times, and
wherein the program further causes the computer to, in a case of changing a position to which the hand points from one specific position to another specific position of the specific positions for each reference period, set unit-period intervals between the rotational movements to be either uniform or non-uniform.

17. The non-transitory computer-readable storage medium according to claim 16, wherein the program causes the computer to perform control to switch between a first state in which the rotational movements corresponding to the unit number of times are performed at uniform intervals and a second state in which the rotational movements corresponding to the unit number of times are performed concentratively in a segment starting from a beginning of each second.

18. The non-transitory computer-readable storage medium according to claim 16, wherein the program causes the computer to change the unit-period intervals corresponding to the unit number of times in order in accordance with predetermined setting values related to the unit-period intervals corresponding to the unit number of times read out from a storage that stores the predetermined setting values.
